(19) United States
(12) Patent Application Publication
(10) Pub. No.: US 2011/0010308 A1
(43) Pub. Date: Jan. 13, 2011

(54) MANAGING DEMOGRAPHIC-BASED CUSTOMER RATINGS

(75) Inventors: Guy Primus, Los Angeles, CA (US); James Lassiter, Los Angeles, CA (US); Michael Brandon Williams, Brooklyn, NY (US)

Correspondence Address: Workman Nydegger;1000 Eagle Gate Tower, 60 East South Temple, Salt Lake City, UT, 84111, US

(73) Assignee: BEEBER, INC., Beverly Hills, CA (US)

(21) Appl. No.: 12/789,232

(22) Filed: May 27, 2010

Related U.S. Application Data
(60) Provisional application No. 61/182,001, filed on May 28, 2009.

(51) Int. Cl. G06Q 30/00

(52) U.S. Cl. 705/347

(57) ABSTRACT

Embodiments are directed to implementing demographic-based user ratings and to aggregating and displaying anonymous user comments. A computer system receives user demographics from multiple different resource users. The computer system receives resource ratings from the resource users, where the resource ratings indicate a level of satisfaction with the resource. The computer system receives a request from a requesting user for a rating of the resource, where the request includes various demographics of the requesting user. The computer system also determines which of the resource users has demographics that optimally match the demographics of the requesting user and present the rating from the resource user determined to optimally match the demographics of the requesting user.

### CROSS-REFERENCE TO RELATED APPLICATIONS

This application claims priority to and is a non-provisional application of U.S. Provisional Patent Application No. 61/182,001 filed May 28, 2009, entitled “MANAGING DEMOGRAPHIC-BASED CUSTOMER RATINGS”, and hereby expressly incorporates by reference the entire contents of that application.

### BACKGROUND

Computers have become highly integrated in the workforce, in the home, in mobile devices, and many other places. Computers can process massive amounts of information quickly and efficiently. Software applications designed to run on computer systems allow users to perform a wide variety of functions including business applications, schoolwork, entertainment and more. Software applications are often designed to perform specific tasks, such as word processor applications for drafting documents, or email programs for sending, receiving and organizing email.

Internet browsers are software applications that allow users to view and interact with web pages. Browsers are often used to view web pages of businesses that provide goods or services for sale over the internet. In many cases, the websites of these businesses allow users to leave comments or other forms of feedback. For instance, many retailers allow product purchasers to leave feedback regarding their experience with purchased items. Other feedback may include product ratings which allow the user to rate a given product or service's effectiveness or relative value.

In some cases, the comments or feedback relate directly to the business or other entity that provides the website. In such cases, the website may allow a user to post comments regarding that business including its personnel, business practices or other topics. Potential customers, when viewing the website, may look at and rely on the user comments when determining whether to patronize that business.

Such user-generated comments, however, may not be based entirely on the user's objective review of that user's interaction with the business or product. Such comments typically vary based on the submitter's perspective, life experiences, expectations and circumstances surrounding his or her interaction with the business. In such cases, some user comments may be more beneficial than other comments to a potential customer.

### BRIEF SUMMARY

Embodiments described herein are directed to implementing demographic-based user ratings and to aggregating and displaying anonymous user comments. In one embodiment, a computer system receives user demographics from multiple different resource users. The computer system receives resource ratings from the resource users, where the resource ratings indicate a level of satisfaction with the resource. The computer system receives a request from a requesting user for a rating of the resource, where the request includes various demographics of the requesting user. The computer system also determines which of the resource users has demographics that optimally match the demographics of the requesting user and present the rating from the resource user determined to optimally match the demographics of the requesting user.

In another embodiment, a computer system receives employer ratings from a first employee, where the identity of the employee is kept anonymous. The computer system receives employer ratings from a second employee, where the identity of the second employee is kept anonymous. The computer system also aggregates the employer ratings received from the first employee and the second employee and displays the aggregated employer ratings of the first employee and the second employee on a web page, so that the employer ratings are visible to potential employees and potential business customers.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

Additional features and advantages will be set forth in the description which follows, and in part will be obvious from the description, or may be learned by the practice of the teachings herein. Features and advantages of the invention may be realized and obtained by means of the instruments and combinations particularly pointed out in the appended claims. Features of the present invention will become more fully apparent from the following description and appended claims, or may be learned by the practice of the invention as set forth hereinafter.

### BRIEF DESCRIPTION OF THE DRAWINGS

To further clarify the above and other advantages and features of embodiments of the present invention, a more particular description of embodiments of the present invention will be rendered by reference to the appended drawings. It is appreciated that these drawings depict only typical embodiments of the invention and are therefore not to be considered limiting of its scope. The invention will be described and explained with additional specificity and detail through the use of the accompanying drawings in which:

FIG. 1 illustrates a computer architecture in which embodiments of the present invention may operate including implementing demographic-based user ratings and aggregating and displaying anonymous user comments.

FIG. 2 illustrates a flowchart of an example method for implementing demographic-based user ratings.

FIG. 3 illustrates a flowchart of an example method for aggregating and displaying anonymous user comments.

FIGS. 4A-4D illustrate various embodiments of sign icons which may be displayed on a given website.

### DETAILED DESCRIPTION

Embodiments described herein are directed to implementing demographic-based user ratings and to aggregating and displaying anonymous user comments. In one embodiment, a computer system receives user demographics from multiple different resource users. The computer system receives resource ratings from the resource users, where the resource ratings indicate a level of satisfaction with the resource. The computer system receives a request from a requesting user for a rating of the resource, where the request includes various demographics of the requesting user. The computer system also determines which of the resource users has demographics that optimally match the demographics of the requesting user and present the rating from the resource user determined to optimally match the demographics of the requesting user.

In another embodiment, a computer system receives employer ratings from a first employee, where the identity of the employee is kept anonymous. The computer system receives employer ratings from a second employee, where the identity of the second employee is kept anonymous. The computer system also aggregates the employer ratings received from the first employee and the second employee and displays the aggregated employer ratings of the first employee and the second employee on a web page, so that the employer ratings are visible to potential employees and potential business customers.

The following discussion now refers to a number of methods and method acts that may be performed. It should be noted, that although the method acts may be discussed in a certain order or illustrated in a flow chart as occurring in a particular order, no particular ordering is necessarily required unless specifically stated, or required because an act is dependent on another act being completed prior to the act being performed.

Embodiments of the present invention may comprise or utilize a special purpose or general-purpose computer including computer hardware, such as, for example, one or more processors and system memory, as discussed in greater detail below. Embodiments within the scope of the present invention also include physical and other computer-readable media for carrying or storing computer-executable instructions and/or data structures. Such computer-readable media can be any available media that can be accessed by a general purpose or special purpose computer system. Computer-readable media that store computer-executable instructions are computer storage media. Computer-readable media that carry computer-executable instructions are transmission media. Thus, by way of example, and not limitation, embodiments of the invention can comprise at least two distinctly different kinds of computer-readable media: computer storage media and transmission media.

Computer storage media includes RAM, ROM, EEPROM, CD-ROM or other optical disk storage, magnetic disk storage or other magnetic storage devices, or any other medium which can be used to store desired program code means in the form of computer-executable instructions or data structures and which can be accessed by a general purpose or special purpose computer.

A “network” is defined as one or more data links that enable the transport of electronic data between computer systems and/or modules and/or other electronic devices. When information is transferred or provided over a network or another communications connection (either hardwired, wireless, or a combination of hardwired or wireless) to a computer, the computer properly views the connection as a transmission medium. Transmissions media can include a network and/or data links which can be used to carry or desired program code means in the form of computer-executable instructions or data structures and which can be accessed by a general purpose or special purpose computer. Combinations of the above should also be included within the scope of computer-readable media.

Further, upon reaching various computer system components, program code means in the form of computer-executable instructions or data structures can be transferred automatically from transmission media to computer storage media (or vice versa). For example, computer-executable instructions or data structures received over a network or data link can be buffered in RAM within a network interface module (e.g., a “NIC”), and then eventually transferred to computer system RAM and/or to less volatile computer storage media at a computer system. Thus, it should be understood that computer storage media can be included in computer system components that also (or even primarily) utilize transmission media.

Computer-executable instructions comprise, for example, instructions and data which cause a general purpose computer, special purpose computer, or special purpose processing device to perform a certain function or group of functions. The computer executable instructions may be, for example, binaries, intermediate format instructions such as assembly language, or even source code. Although the subject matter has been described in language specific to structural features and/or methodological acts, it is to be understood that the subject matter defined in the appended claims is not necessarily limited to the described features or acts described above. Rather, the described features and acts are disclosed as example forms of implementing the claims.

Those skilled in the art will appreciate that the invention may be practiced in network computing environments with many types of computer system configurations, including, personal computers, desktop computers, laptop computers, message processors, hand-held devices, multi-processor systems, microprocessor-based or programmable consumer electronics, network PCs, minicomputers, mainframe computers, mobile telephones, PDAs, pagers, routers, switches, and the like. The invention may also be practiced in distributed system environments where local and remote computer systems, which are linked (either by hardwired data links, wireless data links, or by a combination of hardwired and wireless data links) through a network, both perform tasks. In a distributed system environment, program modules may be located in both local and remote memory storage devices.

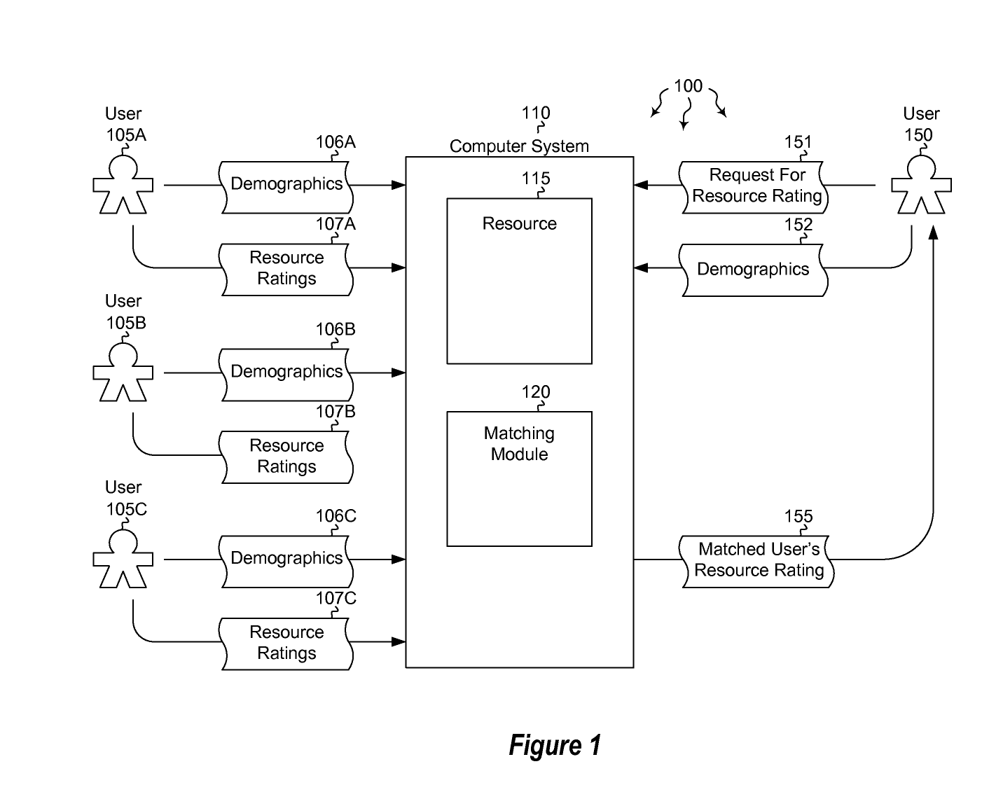

FIG. 1 illustrates a computer architecture 100 in which the principles of the present invention may be employed. Computer architecture 100 includes computer system 110. Computer system 110 includes resource 115. Resource 115, as used herein, may refer to any type of software, hardware, network or other type of resource. In some embodiment, resource 115 may be a website and computer system 110 may be a web server (or at least provide web server functionality). The website may, in some cases, belong to a business or may be a store front for a business. As such, the website may allow user interaction including allowing the user to enter comments, rate products and/or services or leave other types of feedback. The resource (website) may allow users to leave anonymous feedback or may allow the users to register and leave feedback as a registered user.

Users 105A, 105B, 105C and 150 may be any type of computer or website user. In some cases, users 105A-C may be users of resource 115, while user 150 is a potential customer of the business represented by the resource (i.e. the website). Users 105A-C may send resource ratings 107A-C to computer system 110. These resource ratings may rate the resource itself or the provider of the resource. For instance, if the resource is a website provided by a business, the user-provided resource ratings 107A-C may rate the website, products or services provided on the website, or the business providing the website (e.g. rating the manner in which the business handles customer service). These user-provided resource ratings may be accompanied by user demographic information 106A-C.

Demographic information may include any type of information about the user including a name, address, household income, occupation, marital status, email address, password, geography type, number of children, number of children in the house, education level, year of birth, sex, race, sexual orientation, religion, height, weight, national origin or any other type of information about a person or that could be used to describe characteristics of a person. Each user may be able to select which items of demographic information are sent to the web server. In some cases, a user (e.g. 105B) may only provide a small portion of demographic information while in other cases, a user (e.g. 105C) may provide a great deal of demographic information. Users may be compelled to provide more demographic information to increase the quality of user reviews that are presented, as will be explained in greater detail below.

Potential customers or other users that desire to look at user reviews for resource 115 (e.g. user 150) may send a request for resource rating 151 to the resource 115. The request may ask for reviews of a certain type or for reviews that were input by a person of a given demographic. For instance, if resource 115 was a website that sold clothing, user 150 may wish to see reviews provided by someone that was the same gender and approximately the same size as them. In other cases, the resource may provide books and user 150 may wish to see reviews provided by someone of an equivalent education level. These are just two examples among many different possibilities and should not be read as limiting the types or uses of demographic information.

This demographic information may also be used to rate a business on how well they serve or provide services to a particular demographic. For instance, reviewers of one ethnicity may rate a business's services very highly while reviewers of another ethnicity may rate that business's services poorly. As such, potential customers may be alerted that a particular business is more welcoming to one demographic and is less welcoming to another demographic. Thus, potential customer 150 may be able to view the ratings provided by users of a particular ethnicity, religious background, or sexual orientation and determine how well the business provides goods or services to those particular customers.

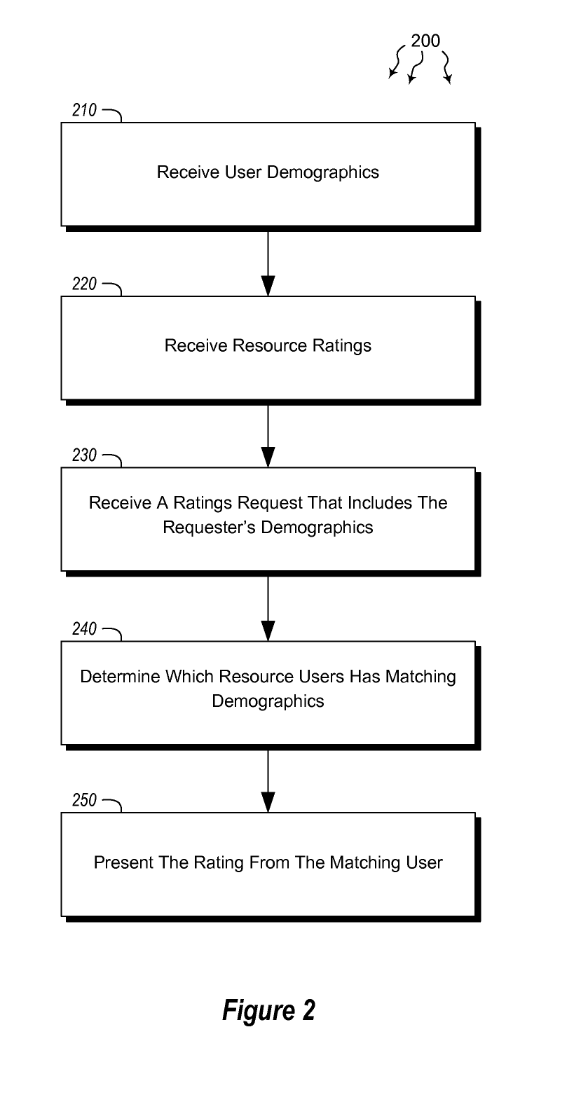

Still further, user 150 may submit with their request for resource rating 151 their own demographic information 152. Upon receiving this, matching module 120 of computer system 110 may match those portions of demographic information provided by user 150 to demographic information of other users. Then, for example, if user 150's demographics matched well with user 105B and user 105C's demographics, user 105B and user 105C's ratings would be shown to user 150, while ratings from other reviewers would not. Upon determining which reviewers' ratings to show, the matched users' resource ratings 155 are returned to user 150. This and other aspects will be explained below with regard to method 200 of FIG. 2.

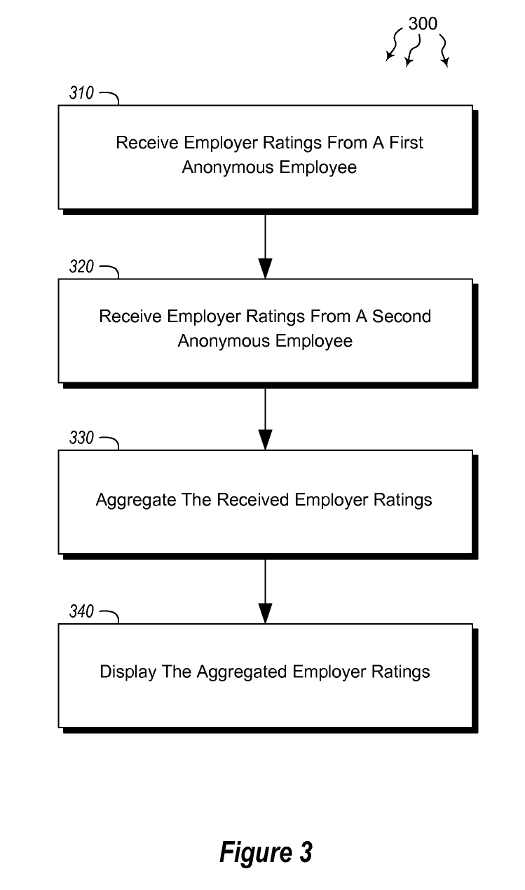

In view of the systems and architectures described above, methodologies that may be implemented in accordance with the disclosed subject matter will be better appreciated with reference to the flow charts of FIGS. 2 and 3. For purposes of simplicity of explanation, the methodologies are shown and described as a series of blocks. However, it should be understood and appreciated that the claimed subject matter is not limited by the order of the blocks, as some blocks may occur in different orders and/or concurrently with other blocks from what is depicted and described herein. Moreover, not all illustrated blocks may be required to implement the methodologies described hereinafter.

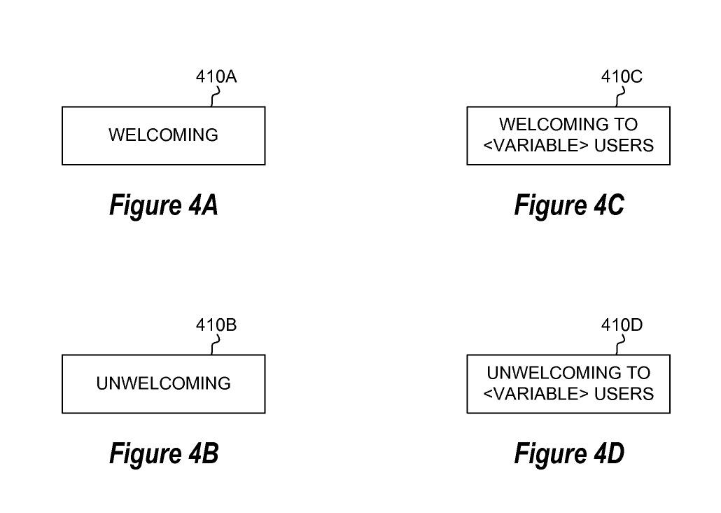

FIG. 2 illustrates a flowchart of a method 200 for implementing demographic-based user ratings. The method 200 will now be described with frequent reference to the components and data of environment 100 of FIG. 1, as well as FIGS. 4A-4D.

Method 200 includes an act of receiving one or more user demographics from a plurality of different resource users (act 210). For example, resource 115 may receive demographics 106A-C from resource users 105A-C, respectively. The actual demographic information sent by each user may be customized by each user. Accordingly, users 105A-C may each select which portions of demographic information they want to send to resource 115. In some cases, the demographics received from the resource users are retrieved from a previously-entered user profile corresponding to the user. Thus, in such cases, where a user has a user profile on store (e.g. in a data store of computer system 110 or some other computer system), that user's demographics can be accessed from the stored profile. In other cases, where resource 115 is a website, a user may manually enter the desired demographic into the website via a submittable form.

Method 200 includes an act of receiving one or more resource ratings from the plurality of resource users, wherein the resource ratings indicate a level of satisfaction with the resource (act 220). For example, resource 115 may receive resource ratings 107A-C from users 105A-C, respectively, where the resource ratings indicate how satisfied the user is with the resource. Thus, in cases where the resource is a business's website, the resource ratings may rate the business itself, the business's website, the business's personnel or other aspects related to the business.

Method 200 includes an act of receiving a request from a requesting user for a rating of the resource, wherein the request includes one or more demographics of the requesting user (act 230). For example, resource 115 may receive request for resource rating 151 and demographics 152 from user 150. In the request, the user may indicate which type of ratings they want to see, or rather, which demographics they want to see ratings from. For instance, the user may have a preference to see reviews by people of the same (or similar) age or same (or similar) number of children. Thus, the user may indicate which demographics are to be matched, resulting in matched user's ratings that match the criteria set by the user. Such ratings may be more pertinent or more relevant to the user than other ratings. These ratings may then influence how the user interacts with the resource (e.g. whether the potential customer decides to patronize the business).

Method 200 also includes an act of determining which of the plurality of resource users has demographics that optimally match the demographics of the requesting user (act 240). For example, matching module 120 may determine which (if any) of resource users 105A-C has demographics that match the demographics of the requesting user (150). In some cases, where multiple users have matching demographics, multiple ratings may be returned. Optionally, the matching module may refine the matching results to return those users that optimally match the demographics of the potential customer.

As mentioned above, the determination as to which of the plurality of resource users has demographics that optimally match the demographics of the requesting user includes may be performed using a multiple different, customizable factors that are (each) to be matched. The requesting user may not only specify which demographics to match, but may also specify the relative importance of each factor or demographic characteristic. Accordingly, the user may specify, for example, that household income and marital status are very important, while age and education level are of lesser importance. In such a case, the ratings users whose demographics match the household income level and marital status criteria will be valued (or determined to more optimally match) higher than those that match only the lesser-importance criteria such as age and education level. Again, it should be noted that these are merely examples of demographic information and match ranking and that many other factors and ranking systems may be used.

In some embodiments, customizable demographic factors or criteria may include behavioral attributes and/or user preferences. Behavioral attributes may include shopping tendencies, purchasing tendencies or other pertinent user behavior, while user preferences may include any type of settings or preference relating to resource 115. In cases where resource 115 is a business's website, users 105A-C may represent previous users of the website and user 150 may represent a potential customer that wants to read reviews before patronizing the business. In such cases, the potential customer may wish to know whether the business is welcoming to all different types of people. Or, the potential customer may only be concerned whether the business is welcoming to a particular demographic (age, gender, ethnicity, religion, etc.). Accordingly, the potential customer 150 may specify which demographics are to be matched, and reviews from users that have those demographics will be returned.

Based on the different ratings and reviews from the business's customers, a third party or other system may be configured to look at the ratings overall or for a particular demographic and determine whether that business is generally welcoming or unwelcoming to users of that demographic. Accordingly, as shown in FIGS. 4A-4D, a third party or the business itself may display an icon on its website indicating that it is welcoming to users of all demographics (410A), is unwelcoming to users of all demographics (410B), is welcoming to <variable> type of users (where <variable> is some portion of demographic information such as age or gender) (410C), or is unwelcoming to <variable>type of users (410D). The wording on the icons 410C/410D may thus change based on which attribute(s) apply. Thus, if a business is welcoming to married users, the sign or icon may read “Welcoming to married users” and if the business is unwelcoming to older users, the sign or icon may read “Unwelcoming to older users.” It will be understood that these are merely examples and that substantially any type of wording indicating that a user is welcome or unwelcome may be used.

Thus, in some cases, potential customer 150 may send his or her ratings request along with their demographic information and receive an (immediate) indication, based on his or her demographics, that the business is generally welcoming or unwelcoming to people of his demographic. That is, based on customer 150's demographics, users with similar demographics that have provided ratings, have rated the business as responding well or poorly to people of a similar demographic. In some cases, the welcome sign (or unwelcome sign) may list some or all of the characteristics of the type of people to which the business is generally welcoming or unwelcoming.

Returning to FIG. 2, method 200 includes an act of presenting the rating from the resource user determined to optimally match the demographics of the requesting user (act 250). For example, computer system 110 may present matched user's resource rating 155 to user 150, where the rating is from one or more users determined to optimally match the demographics of user 150. The presented ratings may be affinitized by demographic. In other words, the ratings may be ranked or categorized according to which demographic criteria or factors the requesting user deemed important. In this manner, the ratings are tailored to the user and the user sees those ratings that are most pertinent and relevant to him or her.

FIG. 3 illustrates a flowchart of a method 300 for aggregating and displaying anonymous user comments. The method 300 will now be described with frequent reference to the components and data of environment 100.

Method 300 includes an act of receiving one or more employer ratings from a first employee, wherein the identity of the employee is kept anonymous (act 310). For example, computer system 110 may receive employer ratings (e.g. ratings 107A) from user 105A, where the identity of user 105A is kept anonymous. The employee ratings may include sensitive information about the employer and, thus, the employee may wish to remain anonymous. The ratings may include an overall rating of the employer, as well as ratings of the employer's different policies, decisions, team members, management, etc. The ratings may also include comments by the employee relating their experiences with the employer. In some cases, stored ratings may be searchable by employer such that a potential employee (e.g. user 150) may search for ratings provided by (current or former) employees of a given employer.

Method 300 includes an act of receiving one or more employer ratings from a second employee, wherein the identity of the second employee is kept anonymous (act 320). Thus, like in the above, computer system 110 may receive employer ratings (e.g. ratings 107B) from user 105B, where the identity of user 105B is kept anonymous.

Method 300 includes an act of aggregating the employer ratings received from the first employee and the second employee (act 330). For example, computer system 110 may aggregate the employer ratings received from users 105A and 105B. In cases where resource 115 comprises a website of a given business or corporation, the users 105A/B may be current or former employees of that business. It will be understood that, while only three users or employees are shown in FIG. 1, substantially any number of ratings may be received from substantially any number of users. All of these ratings may be aggregated and categorized according to the associated user's demographic information.

Method 300 also includes an act of displaying the aggregated employer ratings of the first employee and the second employee on a web page, such that the employer ratings are visible to potential employees and potential business customers (act 340). For example, computer system 110 may display the aggregated employer ratings of employee 105A and employee 105B on website 115. In this manner, the employer ratings are visible to potential employees and/or potential business customers 150. Based on the employee's ratings, the business or a different, third party, may display welcome or unwelcome signs (410A/410B, respectively) on the website. If more information is available and/or desired, the welcome/unwelcome signs may indicate which type of employee the employer is welcome or unwelcome too (e.g. signs 410C/410D, respectively).

In some embodiments, the employee's demographic information (e.g. 106A) may be displayed along with the employee's employer ratings. Thus, a potential employee or potential customer of the business may see the demographics of the reviewer along with their review. This additional information may aid in the potential customer's understanding of the employee's rating. In some cases, computer system 110 may receive a request 151 from a potential employee for a rating of the employer, wherein the request includes one or more demographics 152 of the requesting potential employee. Matching module 120 may then determine which of the plurality of employees has demographics that optimally match the demographics of the requesting potential employee. In this manner, the employer rating from the employee(s) determined to optimally match the demographics of the requesting potential employee may be presented to the potential employee.

Thus, using the systems, methods and computer program products described herein, a potential customer or potential employee may be able to determine what other people like him or herself thinks of the business or employer. Using this information, the user may be able to make a more informed decision as to whether to pursue employment with that employer or whether to patronize that business. Additionally, welcome or unwelcome signs or icons may be presented on the business's website alerting other potential employees or customers that the business is generally welcoming or unwelcoming to different types of people and may, in some cases, specify to which particular demographics the business is welcoming or unwelcoming.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

We claim:

1. At a computer system including a processor and a memory, a method for implementing demographic-based user ratings, the method comprising the following acts:
receiving one or more user demographics from a plurality of different resource users;
receiving one or more resource ratings from the plurality of resource users, wherein the resource ratings indicate a level of satisfaction with the resource;
receiving a request from a requesting user for a rating of the resource, wherein the request includes one or more demographics of the requesting user;
determining which of the plurality of resource users has demographics that optimally match the demographics of the requesting user; and
presenting the rating from the resource user determined to optimally match the demographics of the requesting user.

2. The method of claim 1, wherein the demographics received from the resource users are retrieved from a previously-entered user profile corresponding to the user.

3. The method of claim 1, wherein the demographics received from the resource users are manually entered into a resource interface by the corresponding resource users.

4. The method of claim 1, wherein the resource comprises a business and the resource users comprise business customers.

5. The method of claim 4, further comprising:
determining, based on the rating from the business customer determined to have demographics that optimally match the demographics of a potential business customer, whether the business is generally welcoming of customers having demographics similar to those of the potential customer.

6. The method of claim 4, wherein presenting the rating from the business customer comprises presenting a welcome sign icon upon determining that the business is generally welcoming of customers having demographics substantially similar to the business customer.

7. The method of claim 4, wherein presenting the rating from the business customer comprises presenting an unwelcome sign icon upon determining that the business is generally not welcoming of customers having demographics substantially similar to the business customer.

8. The method of claim 4, wherein presenting the rating from the business customer comprises presenting a welcome sign icon with an indication of those demographics to which the business is generally welcoming.

9. The method of claim 1, further comprising affinitizing the ratings by demographic.

10. The method of claim 1, wherein the requesting user provides a user preference indicating which demographics are to be matched.

11. The method of claim 1, wherein the determination as to which of the plurality of resource users has demographics that optimally match the demographics of the requesting user includes is performed using a plurality of customizable factors that are to be matched.

12. The method of claim 11, wherein the customizable factors include one or more behavioral attributes and one or more user preferences.

13. A computer system comprising the following:
one or more processors;
system memory;
one or more computer-readable storage media having stored thereon computer-executable instructions that, when executed by the one or more processors, causes the computing system to perform a method for aggregating and displaying anonymous user comments, the method comprising the following acts:
receiving one or more employer ratings from a first employee, wherein the identity of the employee is kept anonymous;
receiving one or more employer ratings from a second employee, wherein the identity of the second employee is kept anonymous;
aggregating the employer ratings received from the first employee and the second employee; and
displaying the aggregated employer ratings of the first employee and the second employee on a web page, such that the employer ratings are visible to potential employees and potential business customers.

14. The system of claim 13, wherein the employer ratings are searchable by employer.

15. The system of claim 13, wherein the employer ratings include one or more portions of employee commentary about the employer.

16. The system of claim 13, further comprising displaying employee demographic information corresponding to the employee along with the employee's employer ratings.

17. The system of claim 16, further comprising:
receiving a request from a potential employee for a rating of the employer, wherein the request includes one or more demographics of the requesting potential employee; and
determining which of the plurality of employees has demographics that optimally match the demographics of the requesting potential employee.

18. The system of claim 17, further comprising presenting the employer rating from the employee determined to optimally match the demographics of the requesting potential employee.

19. At a web server including a processor and a memory, a method for implementing demographic-based business customer ratings, the method comprising the following acts:
receiving one or more user demographics from a plurality of different business customers;
receiving one or more business ratings from at least one of the plurality of business customers, wherein the business ratings indicate the customer's opinion of how the business treats customers of various demographics;
receiving a request from a potential customer for a customer rating of the business, wherein the request includes one or more demographics of the potential customer;
determining which one or more of the plurality of business customers has demographics that optimally match the demographics of the requesting customer; and
presenting on a web page the ratings from the business customers determined to optimally match the demographics of the potential customer.

20. The method of claim 19, wherein the demographics received from the plurality of business customers include behavior attributes and preferences.
